(19) United States
(12) Patent Application Publication
(10) Pub. No.: US 2022/0192231 A1
(43) Pub. Date: Jun. 23, 2022

(54) EDIBLE PET CHEW

(71) Applicants: Chongqing Sweet Pet Products Co., Ltd., Chongqing (CN); Shanghai Sunlight Innov Trading Co., Ltd., Shanghai (CN)

(72) Inventors: Chunsheng Li, Chongqing (CN); Xin Mao, Chongqing (CN); Guangqiang Xu, Shanghai (CN); Dequan Shen, Shanghai (CN)

(21) Appl. No.: 17/555,372

(22) Filed: Dec. 18, 2021

(30) Foreign Application Priority Data
Dec. 18, 2020 (CN) 202011509549.5
Jan. 15, 2021 (EP) 21151881.6

(51) Int. Cl. A23K 40/30; A23K 40/25; A23K 10/35; A23K 10/20; A23K 50/42

(52) U.S. Cl. CPC A23K 40/30; A23K 40/25; A23K 50/42; A23K 10/20; A23K 10/35

(57) ABSTRACT

An edible pet chew includes a first high-density material member (or high-density material portion) and a second cellular (low-density) material member (or portion). In one aspect of the present disclosure, an edible pet chew is provided including a high density tube member and a cellular (low-density) material member. In another aspect, an edible pet chew includes a high density sheet member and a cellular (low-density) material member. In another aspect, an edible pet chew includes a co-extruded plural-layered tube member being formed from a layer portion of high density tube material and a layer portion of cellular material. In yet another aspect, an edible pet chew includes a co-extruded “plural-layer-structured sheet” member being formed from a layer portion of high density sheet material and a layer portion of cellular material portion.

### CROSS REFERENCE OF RELATED APPLICATION

This is a non-provisional application that claims priority to Chinese application number 202011509549.5, filed on Dec. 18, 2020. This application also claims priority to EP application number EP21151881.6, filed on Jan. 15, 2021.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT DISCLOSURE

### Field

The field of the present disclosure relates to an edible pet chew. More particularly, the present disclosure relates to an edible pet chew including a low-density material member (or member portion) and a high-density material member (or member portion), primarily for dogs, that is safe and entertaining, and satisfies their instinctive needs to chew.

### DESCRIPTION OF RELATED ARTS

Dogs as carnivorous animals, have inherent urge to chew things. Visiting to a pet store or supermarket makes it readily apparent that there is a wide selection of dog chew products created to accommodate their chewing activities. These products of this kind provide favorable benefits to dogs such as entertaining, exercising jaws, reducing plaque and tartar, freshening breathes and keeping them busy. Edible pet chews are chewed by pets for some time and then swallowed. Traditional rawhide chews and later rawhide alternative chews such as vegetable dental chews were introduced to market with great success widely welcome by dogs and their owners. It is noted that dog treats and dog chews that are addressed in the present disclosure are of dry feeding stuffs (dry feed) rather than moist feed such as wet treat or wet feed, with moisture content substantially less than 25%. Dog chews generally are referring to dry ones in all circumstances.

Of those vegetable dental chews, a kind of low density vegetable/plant based chews (they may also be called puffed/porous/cellular/foamed vegetable-based chews) can be found in the market. Those vegetable-based low density chews may present some benefits such as:

A), Improved plaque/tartar control function than regular high density extruded or injection processed vegetable-based chews. Compared to regular vegetable-based high-density materials similarly formulated, vegetable-based low density chews may be processed by extrusion with some specially modified shearing force parameters and modified extrusion screw profiles. After being processed in an extrusion machine system or an injection one under the modifications, finished products have numerous bubbles/blisters interspersed throughout their whole material body, which may result in an internal porosity structure. Generally speaking, vegetable-based low-density material is softer in rigidity/strength than high density ones. The qualities/properties/characteristics of porosity structure and soft rigidity enable an enlarged tooth contact area than the high density ones while being gnawed, thus an improved plaque/tartar reduction function is achieved.

B), Improved digestibility rate versus the high density ones.

C), More tooth-friendly to puppies and old dogs than the high density ones. With weak teeth, it's safer for puppies and old dogs to gnaw on these vegetable-based low density chews with softer textures as dental chews.

However, these dental chews formed merely from vegetable-based low density material may suffer with some drawbacks as described below.

A), The product has a rough surface due to the presence of bubbles/blisters, especially while applying plant starch-based composite (such as pre-gelatinized starch based composite) to make it. The rough surface makes it not appealing to a lot of potential consumers. The rough/uneven/irregular surface, especially when the rough material exists externally visible to consumers, results in an aesthetically unappealing product.

B), The rough surface makes it unable to imitate traditional rawhide sheet appearance characteristic/property.

C), Not strong and not chewy. They are quite soft and cannot take long time chewing activities.

Of those vegetable dental chews, a new kind of high density vegetable/plant based chews in SHEET or TUBE (pipe) form (especially in a sheet form which serve as a most popular rawhide alternative product) which is typically “free of animal hide ingredient” exist in the market to serve as alternatives to traditional rawhide sheet bones, being intended to overcome some drawbacks of traditional rawhide chews. Another new kind of products similar to these high density vegetable/plant based chews in SHEET/TUBE form are animal ingredient based high density chews in SHEET or TUBE form which includes animal ingredient(s) and less than 50% plant ingredient by weight in formula. As being widely understood, traditional rawhide chews may suffer from several drawbacks, such as the follows. A), Chunks of rawhide broken off during dog's chewing activity may bring a jeopardy of choke to him/her. B), Comparatively low digestibility rate. C), Many dogs find these pet chews lack of substantial flavor and scent. Accordingly, many dogs lose interest with these rawhide pet chews after a while and will at most only chew on them for short periods of time. D), Environmental pollution. It is concerned by many people that manufacture of rawhide is relatively unregulated industry. Producing the raw material of rawhide is known to use a bunch of chemicals and therefore generate evident pollution during its splitting, cleaning, washing and bleaching processes. The water system may also be harmed and polluted accordingly. E), Detrimental residues in rawhide from primary processing. When primarily processing rawhide, lime solution, NH4CL, H202, and NaOH may be used during its splitting, cleaning, washing and bleaching processes and may remain in some finished products more or less. These chemicals are not good for pets' health. For example, excessive H2O2 will cause pets vomit or even worse symptom. What's more, heavy metals, for example lead may also remain in the rawhide and accumulate in the body, which cause serious damage to the pets' health. These concerns encourage a perception for pets/dogs owners to look for alternative ways to provide a “pet chew” for their pets without the use of rawhide/porkhide material or animal hide ingredients.

These aforementioned plant-based (or animal ingredient based) chews in a sheet/tube form are created to imitate the visual appearance/shape of traditional rawhide chews, as well as their chewing functions. “Smartbones” branded rawhide-free plant-based chews in a sheet form distributed by Petmatrix, LLC company from USA are well recognized as a representative of this effort. Another example is “Milk-Bone” “GnawBones” brand rawhide-free chews distributed by Big Heart Pet Brands, Inc. (J.M. Smucker). These “GnawBones” have a tube form member plus a narrow sheet one which are assembled together to form a knotted bone configuration in an alternating layer relationship. Those sheet/tube formed vegetable-based (or animal ingredient based) chews may present some benefits such as:

A), They can well imitate the appearance/shape and chewing function of traditional animal hide dog chews, especially the ones made of sheet form material. Comparing Sheet form materials and Tube/pipe form ones, it appears that sheet formed ones may better achieve those imitation jobs than tube formed ones, where sheet form materials have much more varieties in configurations in the intension to imitate traditional rawhide sheet chews since standard rawhide is in a similar sheet form as well, which makes “sheet form” an extremely more popular rawhide sheet alternative than “tube form”. Tube form material can only do that imitation job in limited varieties. These well-imitated characteristics enable these sheet/tube form products to work well as an alternative to traditional rawhide chews. These sheet or tube formed materials have smooth material surfaces resembling a traditional rawhide, which is much more welcome by consumers than a material with rough exterior surfaces.

B), They are chewy that can last for fairly long time as a dog chew before being swallowed, thanks to their good rigidity or strength characteristic. They provide good jaw exercising function. And the extended chewing time offers a longer entertaining time and a way to keep dogs busy longer.

However, these dental chews formed merely from sheet/tube structured vegetable-based (or animal ingredient based) material suffer with some drawbacks as described below.

A), Unsatisfactory tartar/plaque control function. Firstly, the dogs may find these products do not satisfyingly reduce their tartar/plaque due to their chewy characteristic/property and fairly smooth surface. Secondly, these vegetable-based (or animal ingredient based) high density chewy sheet/tube usually are very thin in thickness (with an intention to mimic traditional rawhide sheet), creating a problem that dog teeth do not penetrate very deeply into the chew before breakage.

B), Comparatively lower digestibility level than low density plant based materials.

C), Some puppies and old dogs may not be able to endure the hardness/rigidity of these high-density material sheet/tube products.

U.S. Pat. No. 7,677,203 entitled “Edible pet chew”, filed on Nov. 21, 2006 and U.S. Pat. No. 8,455,025 entitled “Edible pet chew made from a single initially malleable sheet”, filed on Apr. 21, 2010 by Stern, disclose a pet chew made from a plant based chewy sheet. However, these disclosures did not disclose any low density plant based materials or members existing in the chews. The aforementioned “Smartbones” brand dog chews were developed under the U.S. Pat. No. 7,677,203. U.S. Pat. No. 7,677,203 merely mentioned the edible pet chew may additionally include a new “chewy edible material” in it but was silent about a low density plant based material member or portion. It also should be noted that either the “chewy sheet” or “chewable material sheet” is not a low-density material. Therefore, these disclosures suffer with the aforementioned drawbacks of the products made from merely a plant based chewy sheet. It should also be noted that the two layered “single sheet” component from U.S. Pat. No. 8,455,025 has two “sheet” (“sheet” in a narrow sense as undermentioned) portions as its layers, which differs from the “plural-layered-structured sheet” member undermentioned including a first layer of sheet form and a second layer of low density portion with rough surfaces. The “plural-layer-structured sheet” cannot be identified as the “sheet” as disclosed by U.S. Pat. No. 8,455,025 although it has a first layer of “sheet” (“sheet” in a narrow sense) form material. US 2013/142936 (U.S. application Ser. No. 13/749,892) entitled “edible pet chew made from an edible malleable sheet”, filed on Jan. 25, 2013 by Stern, discloses a pet chew including a hardened chewable sheet, which may further include a second chewy edible material sheet. However, it is silent about a pet chew component of low-density material which has an internal structure with a lot of air bubbles or cavities.

U.S. Pat. No. 8,776,728 entitled “Edible pet chew”, filed on Mar. 21, 2011 by Xu, U.S. Pat. Nos. 9,044,039 and 9,770,044 disclosed a pet chew made of meat based chewy sheet which has less than 50% plant ingredient in sheet formula. They are silent about a low density plant based material member or portion of a member. U.S. Pat. No. 9,044,039 disclosed a plural layered co-extruded material formed from a first part of meat-based material sheet and a second part of another “edible material” sheet. However, it is silent about a low density part which is integrated with another high-density material sheet. It is silent about any member with a low density part/portion.

PCT/IB2015/058896 entitled “Low density animal edible chew and methods of making the same”, filed on Nov. 17, 2015 by Yannick Mahe, disclosed an expanded low density chew with a smooth exterior surface. It is silent about any additional separate high density sheet/tube members or co-extruded high density sheet/tube form portions existing in the chew, which may imitate appearance characteristic or functions of a traditional rawhide sheet. Without the features that it imitates the characteristics of a traditional rawhide, it does not have the aforementioned benefits that will be potentially provided by the features.

WO 2018/124880 A1 entitled “Method of producing edible pet chew product and product produced thereby”, filed on Dec. 27, 2017 by Pater, disclosed a pet chew having a skin of first starch-based material and a core of a second. It is silent about an edible pet chew formed from a co-extruded “plural-layer-structured SHEET” member which includes a first layer (portion) of high-density material and a second layer (portion) of low-density material. It is silent about a pet chew with a co-extruded “plural-layer-structured SHEET” member including a first layer of high density SHEET form material and a second layer of a low-density material. It is silent about a pet chew with a first co-extruded “plural-layer-structured sheet” member and a second member of animal ingredient-based material, where the first co-extruded “plural-layer-structured sheet” member including a first layer of high density SHEET form material and a second layer of a low-density material. It is silent about an edible pet chew formed from a co-extruded TUBE member which includes a first layer (portion) of high-density material and a second layer (portion) of low-density material. It is silent about a pet chew with a co-extruded TUBE member including a first layer of high density TUBE form material and a second layer of a low-density material. It is silent about a pet chew with a first co-extruded tube member and a second member of animal ingredient-based material, where the first co-extruded tube member including a first layer of high density TUBE form material and a second layer of a low-density material. It is silent about a pet chew including a separate sheet member and a low density member. It is silent about a pet chew including a separate sheet member and a low density member, where the low density member has an animal ingredient-based material core. It is silent about a pet chew including a separate tube member and a low density member. It is silent about a pet chew including a separate tube member and a low density member, where the low density member has an animal ingredient-based material core. The skin portion of the edible pet chew disclosed by Pater fails to include the feature of “thin” and substantially homogenous thickness as a sheet or tube form material does. Since its skin is not a separate member existing in the pet chew product, it cannot present the features of imitating traditional rawhide sheet. Also, it is silent about an intention to introduce a pet chew member or a portion of a member imitating the characteristics of a traditional rawhide sheet. Without the features that it imitates the characteristics of a traditional rawhide, it does not have the aforementioned benefits that will be potentially provided by the features.

Attention is also directed to the following disclosures: U.S. application. Ser. No. 15/845,521 entitled “Pet chew and treat made of extruded material”, filed on Dec. 18, 2017; China Appl. No. 201610630054.5 entitled “An edible pet chew”, filed on Aug. 3, 2016; application. No. PCT/US2013/066255 entitled “Aerated injection molded pet chew”, filed on Oct. 22, 2013; application. No. PCT/GB20 14/050964 entitled “Edible animal chew”, filed on Mar. 26, 2014.

Accordingly, what is needed is an edible pet chew to overcome the problems and disadvantages of the prior arts.

### SUMMARY OF THE PRESENT DISCLOSURE

An objective of the present disclosure is to provide an edible pet chew product intended to be chewed by a dog for an extended period of time before being digested. The pet chew may keep the dog's teeth clean, freshen breath and exercise its jaws.

An embodiment of the present disclosure is to provide an edible pet chew product equipped with a high-density chewy sheet/tube member that is with satisfied rigidity/hardness/strength, which can endure a dog's relatively long time gnawing/chewing activity before being swallowed.

An embodiment of the present disclosure is to provide an edible pet chew product equipped with a plant/vegetable-based (or animal ingredient based) low-density material member, soft and cellular, which can significantly increase contact area with dog's teeth while being gnawed, and thus achieve an improved plaque/tartar reduction function.

An embodiment of the present disclosure is to provide an edible pet chew that is free of animal hide material, or free of rawhide in its formula.

An embodiment of the present disclosure is to provide an edible pet chew with 3 different members or portions, each of the 3 provides their respective functions that can be distinctly defined to the chew product. In some embodiments of the present disclosure, a first member/portion primarily provides long time chewing function with its hardness/strength, a second member/portion provides intensified tooth cleaning function with its cellular structure with numerous air bubbles and softness, and a third member/portion, an edible material, provides major attractant function with strong attractive flavor or animal ingredients. Thus 3 functions can be achieved with a single feed. The edible material member/portion is preferably positioned within a pet chew product or is wrapped therein. The presence of the edible material member/portion can encourage dogs to chew and the dogs will eat starting with the exterior member/portion of the pet chew before their reaching the inner edible material member/portion. Dogs are attracted by the edible material member/portion wrapped therein but they can't reach it unless they ingest the exterior one which conceals it. In this pattern, the pet chew achieves continuing attraction to dogs through their chewing time.

In some embodiments of the present disclosure, an edible pet chew is provided with 3 different members or portions, each of the 3 provide their respective functions that can be distinctly defined to the chew product, where a first member/portion is a plant based (or animal ingredient based) high density chewy sheet/tube, a second member/portion is an extruded plant based (or animal ingredient based) low-density material, and a third member/portion is an extruded rawhide-free animal ingredient-based material (such as meat based) in a shape.

Some embodiments of the present disclosure is to provide an edible pet chew with a sheet or tube form material which can well imitate qualities/characteristics of traditional animal hide sheet such as the appearance quality (thin, flat and smooth surface), shape quality and chewy quality.

In one aspect of the present disclosure, an edible pet chew is provided combining/including a first member of plant/starch based (or animal ingredient based) high density TUBE (pipe) form material and a second member of a plant/starch based (or animal ingredient based) low-density material, which are assembled together in a relationship. The chewy function of the edible pet chew product is substantially or primarily fulfilled by the tube material.

In some embodiments of the present disclosure, an edible pet chew product is provided including a first member of high density TUBE form plant/starch based material (or animal ingredient-based material) and a second plant/starch based (or animal ingredient based) material low density member, and a third edible material member/portion (the third edible material member/portion is preferably a flavored material, an animal ingredient-based material or an edible material that is more palatable than the tube member and the low-density material member) positioned in the low-density material member, where the third edible material member may be positioned in the second low density member by co-extrusion process. Functions of the members/portions: the first member of tube material works as a primary chewy material; the second member of low-density material works as a primary teeth cleaning material; the third flavored material (or animal ingredient-based material) member/portion works as an attractant enticing dogs to chew on the product.

In another aspect of the present disclosure, an edible pet chew is provided combining/including a first member of high density SHEET form plant/starch based (or animal ingredient based) material and a second member of a low density plant/starch based (or animal ingredient based) material, which are assembled together in a relationship. The chewy function of the edible pet chew product is substantially or primarily fulfilled by the sheet material.

In some embodiments of the present disclosure, an edible pet chew product is provided combining a first member of high density SHEET form plant/starch based (or animal ingredient based) material and a second member of a low density plant/starch based (or animal ingredient based) material, and a third edible material member/portion (the third edible material member/portion is preferably a flavored material, an animal ingredient-based material or an edible material that is more palatable than the sheet member and the low-density material member) positioned in the low-density material member, where the third edible material member may be positioned in the second low density member by co-extrusion process. Functions of the members/portions: the first member of sheet material works as a primary chewy material that can endure a dog's long time gnawing activity; the second member of low-density material works as a primary teeth cleaning material; the third animal ingredient based (or flavored material) edible material member/portion works as an attractant enticing dogs to chew on the product.

In another aspect of the present disclosure, an edible pet chew is provided being formed from a “plural-layer-structured sheet” member combining/including a layer of plant based (or animal ingredient based) high density chewy sheet that is with satisfied rigidity/hardness/toughness which can endure a dog's long-time gnawing/chewing activity before being swallowed and a layer of vegetable-based (or animal ingredient based) low density material. The chewy function of the edible pet chew product is substantially or primarily fulfilled by the layer portion of chewy sheet.

In some embodiments of the present disclosure, an edible pet chew product is provided including a “plural-layer-structured sheet” member and another edible material (an animal ingredient-based material, a flavored material or an edible material that is more palatable than the chewy sheet portion and the low-density material portion) member, which are assembled together in a relationship. The “plural-layer-structured sheet” material member combining/including a layer of vegetable-based (or animal ingredient based) high density chewy sheet that is with satisfied rigidity/hardness/toughness which can endure a dog's long time gnawing/chewing activity before being swallowed and a layer of vegetable-based (or animal ingredient based) low density material.

In one aspect of the present disclosure, an edible pet chew is provided being formed from a plural-layer-structured TUBE member combining/including a layer of plant based material (or animal ingredient-based material) high density chewy tube that is with satisfied rigidity/hardness/toughness which can endure a dog's long time gnawing/chewing activity before being swallowed and a layer of vegetable-based (or animal ingredient based) low density material. The chewy function of the edible pet chew product is substantially or primarily fulfilled by the portion of chewy tube.

In some embodiments of the present disclosure, an edible pet chew product is provided including a plural-layer-structured TUBE member and an animal ingredient-based material (or a flavored material, or an edible material that is more palatable than the chewy tube portion and the low-density material portion) member, which are assembled together in a relationship. The plural-layer-structured tube material member combining/including a layer of vegetable-based (or animal ingredient based) high density chewy tube that is with satisfied rigidity/hardness/toughness which can endure a dog's long-time gnawing/chewing activity before being swallowed and a layer of vegetable-based (or animal ingredient based) low density material.

In another aspect of the present disclosure, an edible pet chew is provided combining/including a first component of bar-shaped plant/starch based (or animal ingredient based) high density (or strip-shaped) material and a second component of a plant/starch based (or animal ingredient based) low-density material, which are assembled together in a relationship. The chewy function of the edible pet chew product is substantially or primarily fulfilled by the bar-shaped material component.

In yet another aspect of the present disclosure, an edible pet chew is provided combining/including a component of bar-shaped (or strip-shaped) material, in which the bar-shaped (or strip-shaped) material includes a first portion of plant/starch based (or animal ingredient based) high-density material and a second portion of plant/starch based (or animal ingredient based) low density material.

These embodiments of the present disclosure will become apparent from the following detailed description, the accompanying drawings, and the appended claims.

### BRIEF DESCRIPTION OF THE DRAWINGS

Embodiments are described in conjunction with reference to the following drawings, where:

FIG. 1 is a top plan view of an edible pet chew according to an embodiment of the present disclosure, in a knotted bone form. It is formed from a plant/vegetable-based (or animal ingredient based) high density chewy tube member surrounding a strip shaped plant based (or animal ingredient based) low-density material member whose cross-section outline shape is substantially a narrow rectangle.

FIG. 2 is a cross sectional view of 9 exemplary materials in preparation to form edible pet chew products, being formed from a plant/vegetable-based (or animal ingredient-based) chewy tube member surrounding a tube or strip/cylinder shaped plant based (or animal ingredient-based) low-density material member. 3 of the 9 products have an additional edible material member serving as a core of the low-density material member, which is formed by co-extrusion process.

FIG. 3 is a perspective view of an edible pet chew according to an embodiment of the present disclosure, in a cylindrical stick form. It is formed from a plant/vegetable-based (or animal ingredient based) chewy tube member wrapping a cylindrical plant based (or animal ingredient based) low density member with a core member of flavored or animal ingredient-based material.

FIG. 4 is a top plan view of an edible pet chew according to an embodiment of the present disclosure, in a knotted bone form. It is formed from a plant/vegetable-based (or animal ingredient based) chewy sheet member wrapping 3 individual chunk members made of plant based (or animal ingredient based) low-density material.

FIG. 5 is a top plan view of an extruded plant based (or animal ingredient based) chewy sheet member imitating traditional rawhide sheet and a co-extruded composite material combining a plant based (or animal ingredient based) low-density material member and an additional meat based edible material member, in which the chewy sheet member and the co-extruded composite material overlap each other, in preparation of being applied to form an edible pet chew according to an embodiment of the present disclosure. The meat based edible material member is with a substantially-rectangular cross section outline shape.

FIG. 6 is a top plan view of an edible pet chew according to an embodiment of the present disclosure, in a knotted bone form. It is formed from an extruded plant based (or animal ingredient based) chewy sheet member and a co-extruded composite material including a plant based (or animal ingredient based) low-density material member and an additional edible material member (meat based), which are assembled together forming alternating layers of the product. The edible material member is with a substantially-rectangular cross section outline shape, working as a core to the low-density material member.

FIG. 7 is a top plan view of an edible pet chew according to an embodiment of the present disclosure, in a twisted stick shape. It is formed from a high density extruded vegetable-based (or animal ingredient based) chewy sheet member and an co-extruded composite material including a vegetable-based (or animal ingredient based) low-density material cylindrical stick member and an additional edible material member (animal ingredient based), where the chewy sheet member wraps about the co-extruded composite material. The low-density material member has an animal ingredient-based material core.

FIG. 8 is a top plan view of a co-extruded “plural-layer-structured sheet” member combining/including a layer of plant based (or animal ingredient based) high density chewy sheet material and a layer of vegetable-based (or animal ingredient based) low density material, in preparation of being applied to form an edible pet chew according to an embodiment of the present disclosure.

FIG. 9 is a cross section view of the co-extruded “plural-layer-structured sheet” member as described in FIG. 8.

FIG. 10 is a cross section view of a co-extruded triple layered sheet member combining/including two layers of high density chewy sheet and an internal layer of vegetable-based (or animal ingredient based) low density material, in preparation of being applied to form an edible pet chew according to an embodiment of the present disclosure.

FIG. 11 is a top plan view of an edible pet chew according to an embodiment of the present disclosure, in a knotted bone form, being formed from a co-extruded two layered “plural-layer-structured sheet” member combining/including a layer of plant based (or animal ingredient based) high density chewy sheet material and a layer of vegetable-based (or animal ingredient based) low density material.

FIG. 12 is a top plan view of an edible pet chew according to an embodiment of the present disclosure, in a twisted stick form, being formed from a co-extruded two layered “plural-layer-structured sheet” member combining/including a layer of plant based (or animal ingredient based) material high density chewy sheet and a layer of vegetable-based (or animal ingredient based) low density material.

FIG. 13 is a top plan view of an edible pet chew according to an embodiment of the present disclosure, in a twisted stick form, being formed from a first member of a co-extruded two layered “plural-layer-structured sheet” and a second member of an extruded edible material in cylindrical shape, where the former wraps about the latter. The first two layered “plural-layer-structured sheet” member combines a layer of plant based (or animal ingredient based) high density chewy sheet and a layer of vegetable-based (or animal ingredient based) low density material.

FIG. 14 is a top plan view of an edible pet chew according to an embodiment of the present disclosure, in a knotted bone form, being formed from a co-extruded two layered tube member combining/including a layer of plant based (or animal ingredient based) high density chewy tube material and a layer of vegetable-based (or animal ingredient based) low density material.

FIG. 15 is a top plan view of an edible pet chew according to an embodiment of the present disclosure, in a knotted bone form, being formed from first member of a co-extruded two layered tube material and a second member of a flavored material, where the former wraps about the latter. The first two layered tube member combines a layer of plant based (or animal ingredient based) high density chewy tube material and a layer of vegetable-based (or animal ingredient based) low density material.

FIG. 16 is a perspective view of an edible pet chew according to an embodiment of the present disclosure, in a knotted bone form. It is formed from a plant/vegetable-based (or animal ingredient based) chewy tube member enveloping a cylindrical plant based (or animal ingredient based) low density member with a core of flavored or animal ingredient-based material.

### DETAILED DESCRIPTION OF THE EMBODIMENTS

Embodiments are provided in the following description only as examples and modifications will be apparent. The general principles defined in the following description would be applied to other embodiments, alternatives, modifications, equivalents, and applications without departing from the spirit and scope of the present disclosure.

It should be noted that the term “traditional rawhide” sheet in the present disclosure is a most popular material to form dog chews in the pet industry, generally referring to skin/hide by-product(s) obtained from the slaughter of animals (especially hoofed animals such as bovine, swine, cattle, cow, water buffalo, pig, sheep, goats, marsupial, deer and elk). The hide is not exposed to tanning process and generally fur, meat and fat is removed. The dry material of traditional rawhide is mainly made of fibrous proteins, collagen, keratin, elastin and reticulin and water.

The term of “sheet” in the present disclosure generally refers to a thin flat material, which is thin in comparison to its length and breadth, typically in square or rectangular shape. Typically, one surface or both two opposite surfaces of the “sheet” are substantially smooth. In a narrow sense, the “sheet” refers to a single-layered thin flat material with two smooth opposite surfaces. In one embodiment, the “sheet” may have a continuous longitudinal ridge part attached to the “sheet” main body running at a latitudinal end of it, through the full length of the “sheet” main body. Preferably, the thickness of the “sheet” is substantially homogeneous throughout the material. Typically, the average thickness of it ranges from 0.3 mm to 10 mm. The term of “chewy” in the present disclosure generally refers to a feature of an edible material that is in a rigidity/hardness and/or toughness/flexibility, which can endure a dog's (fairly) long time chewing before it is swallowed by it. The hardness of a “chewy sheet” or “chewy tube” material may typically range from Shore D 15 to 65. As a comparison, the term of “plural-layer-structured sheet” in the present disclosure generally refers to a thin flat material in a plural layer structure, which includes at least one aforementioned “sheet” (the “sheet” herein is a “sheet” in a narrow sense) material layer. The distance between the two opposite surfaces (the top and bottom surfaces) of the “plural-layer-structured sheet” in comparison to its length and breadth is very small, in which one of the two opposite surfaces typically may be rough. In one embodiment, the “plural-layer-structured sheet” includes a first layer of sheet form material and a second layer of low-density material (low-density material in flat form). In one embodiment, the “plural-layer-structured sheet” includes a first layer of sheet form material and a second layer of low-density material (low-density material in a non-flat form, such as a cylindrical form, a stick form with cross section of rectangle and a stick form with cross section of star, etc.). Typically, the average thickness of it ranges from 2 mm to 20 mm. Taking pet chew component 0800 from FIG. 8 as an instance, 0800 as a whole is a “plural-layer-structured sheet” but is not a “sheet” in a narrow sense as described above, as it has plural layers with one of its surfaces being rough.

The term of “tube” or “pipe” in the present disclosure generally refers to a long hollow object whose cross section is usually round or oval. Typical cross section of the tube/pipe is in an outline being round (circular). But outline shape of the tube/pipe cross section may be in various shapes, such as an oval shape, a rectangular shape, a shape resembling arabic numerals “8” (twin-tube form), a shape of three-hole (a triple-tube form shape product), and irregular shapes. Preferably, the thickness of the wall of the “tube” or “pipe” is substantially homogeneous throughout the material. Typically, the average wall thickness of it ranges from to 0.3 mm to 10 mm. Preferably, the exterior surface of it is smooth. It should be noted that, in the trade, while forming a pet chew product, both extruded “tube” material and extruded “sheet” material are considered being able to fulfil the “rawhide sheet imitation” or “rawhide sheet alternative” job since generally both of them have a rawhide-like structure/surface while forming a pet chew product. In a sense, “tube” material may be viewed as a “sheet” when it is cut open longitudinally through its length at one tube wall, and “sheet” material may be viewed as a “tube” when it is rolled to a roll with two initially-opposite long sides meeting each other. When a rawhide sheet material is manipulated (for example by folding, knotting, rolling or twisting) into a complicated final product structure, this final product structure may be well fulfilled by manipulating a tube (initially) material. Of course, while comparing Sheet form materials and Tube form ones, it is understood that sheet formed ones can better achieve the “rawhide sheet imitation” jobs than tube formed ones, where sheet form materials have much more varieties in configurations in the intension to imitate traditional rawhide sheet chews since standard rawhide is in a similar sheet form as well, which makes “sheet form” an more popular rawhide sheet alternative than “tube form”. Tube form material can only do that imitation job in limited varieties.

It should be noted that the term “low density” material in the present disclosure is a material with an internal structure with a lot of air bubbles or air-filled cavities (in some embodiments, made of plant-based composite/composition including at least 50% plant ingredients by weight on an as fed basis (or on a dry matter basis alternatively)), with a bulk density typically between 0.15 g/cm³ and 1 g/cm³ (more typically between 0.3 g/cm³ and 1 g/cm³), with less than 25% moisture content. In some embodiments, the “low density” material is made of animal ingredient based composite/composition including at least 10% animal ingredient and 5%-49.9% plant ingredient by weight. Preferably, the “low density” material is with porous texture. The low-density material may also be called “puffed”, “cellular”, “porous”, “foamed” or “expanded” material. Typically, the material has numerous bubbles/blisters interspersed into the whole material. Typically, the low-density material is formed from a starch-based composite/composition including at least 20% starch ingredients by weight on an as fed basis (or on a dry matter basis alternatively). Preferably, the low-density material is free of animal hide ingredient in its formula. Preferably, it is free of rawhide ingredient in its formula. Typically, it is an extruded material being formed by extrusion process. But it may be formed by other alternative processes such as injection. It may be applied in a dog chew product so that it allows animal teeth to penetrate more deeply into the chew, thereby providing a mechanical cleansing function. The “low density” component may be in any desired forms or shapes. In some embodiments to form an edible pet chew of the present disclosure, the “low density” component may be in a form such as sheet, bar, strip, stick, cylinder, tube, etc.

The “starch” in the present disclosure generally refers to the carbohydrate food substance obtained from a plant. Some examples are starches derived from potato, sweet potato, mung bean, wheat, corn, tapioca, rice, pea and mixtures thereof. The starch can be used in native form, but may also be physically or chemically modified before being applied. Of course, it is also possible to use combinations of native starch and modified starch, or combinations of different modified starches.

Compared to aforementioned “low density” materials, the term of “high density” material in the present disclosure refers to the kind of common plant based (or animal ingredient based) extruded material whose internal structure generally is free of air bubble or air filled cavity, with a bulk density typically between 0.8 g/cm³ and 2 g/cm³ (more typically between 0.9 g/cm³ and 1.6 g/cm³), which generally has relatively higher density than those cellular “low density” materials provided that the high density and low density ones are similarly formulated. Generally, the “high density” material is free of porous texture. It may also be called “non-puffed”, “non-cellular”, “non-porous” or “non-foamed” material. Generally, in an edible pet chew product developed according to the present disclosure having both “high density” and “low density” members/portions/materials, the bulk density of its “high density” member/portion/material is relatively higher than its “low density” member/portion/material, in which its “high density” member/portion/material is over 10% (in one embodiment, over 20%) higher than its “low density” member/portion/material in bulk density. The word of “high” from “high density” refers to being relatively high. Generally, “high density” material has relatively higher hardness/rigidity/strength than those cellular “low density” materials. Serving as an alternative to rawhide material, the “high density” material is most popularly applied to form a pet chew product as an extruded material in the industry in comparison to the low density ones. Typically, it is an extruded plant or starch-based material, which provides lower raw material cost than animal ingredient based one. Typically, the high-density material is formed from a starch-based composite/composition including at least 20% starch ingredients by weight on an as fed basis (or on a dry matter basis alternatively). Preferably, the high-density material is free of animal hide ingredient in its formula. Preferably, the high-density material is free of rawhide ingredient in its formula. Typically, the surfaces of it are smooth in texture.

It should be noted that the term “plant” in the present disclosure generally refers to an edible part of a plant material, where the plant material selected from, but not limited to, the group consisting of: a plant material (such as potato, sweet potato, mung bean, wheat, corn, tapioca, rice, pea, soybean, peanut, almond, mushroom, legumes, beans, grains, chia seed, algae, seaweed, spirulina, cereals and mixtures thereof), a material of plant edible part, a plant derived material, a plant protein, a plant starch, a plant fiber, a vegetable material, a vegetable derived material, a vegetable protein, a vegetable starch and mixtures thereof.

The term of “plant based” refers to a composite material including substantially at least 50% plant ingredient(s) by weight on an as fed basis (or on a dry matter basis alternatively). Typically, all plant ingredients (such as plant starch, plant protein, plant fibers) existing in the “plant based” composite/composition added together account for the number one ingredient(s) in the material by weight on an as fed basis (or on a dry matter basis alternatively), which is larger than any other individual (or single) non-plant ingredient existing in the material, such as glycerin, chicken, chicken liver and sorbitol. Preferably, a plant-based material of the present disclosure is free of animal hide ingredient or rawhide ingredient.

The term of “animal ingredient” in the present disclosure refers to the materials including meat, meat by-product(s) or a combination thereof, other than skin, feather, horn, hair, teeth, hooves. The term of “meat” generally refers to the clean flesh derived from slaughtered animals (including but not limited to mammals, livestock, bovine, swine, cattle, pig, poultry, chicken, duck, turkey and fish) and is limited to that part of the striate muscle which is skeletal or that part which is found in the tongue, in the diaphragm, in the heart or in the esophagus. In other words, “meat” is primarily the muscle tissue of an animal. Exemplary materials are chicken flesh, beef, pork, fish flesh. The term of “meat by-products” generally refers to the non-rendered, clean parts, other than meat, derived from slaughtered animals (such as mammals and poultry), which includes, but is not limited to, lungs, spleen, kidneys, brain, livers, blood, bone, partially defatted low-temperature fatty tissue and stomachs and intestines free of their contents. It may also include milk, cheese, whey and egg. Some more exemplary materials are chicken liver, beef tendon, bovine lungs, porcine fat, animal bone powder, animal stomach.

The term of “animal ingredient based” material refers to a composite material including substantially at least 10% animal ingredient(s) by weight and 5%-49.9% plant ingredient. Preferably, all animal ingredients (such as chicken flesh, beef, pork, goat muscle, chicken liver, beef tendon, animal lungs, porcine fat, animal bone powder, animal stomach, etc.) existing in the “animal ingredient based” composite/composition added together account for the number one proportion ingredient(s) by weight in the material, which is larger than any other individual (or single) non-animal ingredient existing in the material, such as potato starch, ground pea, isolated soybean protein, plant starch, plant protein, glycerin, sugar, sorbitol. More typically, the composite/composition material includes substantially at least 30% animal ingredient(s) and 5%-49.9% plant ingredient(s) by weight. Preferably, the animal ingredient-based material is free of animal hide ingredient or rawhide ingredient. “Meat based” material refers to a composite material including substantially at least 10% meat ingredient(s) and 5%-49.9% plant ingredient(s) by weight. Typically, the meat-based material composite includes substantially at least 30% meat ingredient(s) and 5%-49.9% plant ingredient(s) by weight. In one embodiment, all meat ingredients (such as chicken breast, duck, beef, pork, goat muscle, etc.) existing in the “meat based” composite/composition added together account for the number one proportion ingredient(s) by weight in the material, which is larger than any other individual (or single) non-meat ingredient existing in the material, such as potato starch, ground pea, isolated soybean protein, plant starch, plant protein, glycerin, sugar, sorbitol.

The term of “flavored material” refers to a plant-based material with an additional flavor ingredient in its formula. The flavor ingredient improves the attraction/palatability of the “flavored material” enticing dogs to chew on. Examples of the flavor ingredient are meat ingredient, meat by-products ingredient, chicken liver, hydrolyzed animal protein, poultry digest, chicken digest, artificial beef flavor, artificial pork flavor and brewer yeast.

It should be noted that the term “assemble” means to fit together all separate parts/members/components of a pet chew/treat product. For example, the separate components are manipulated (such as knotting, wrapping, rolling, folding and twisting) by hand or extrusion/injection/molded/rolling process by machine to have the components together form a pet chew product in a predetermined relationship.

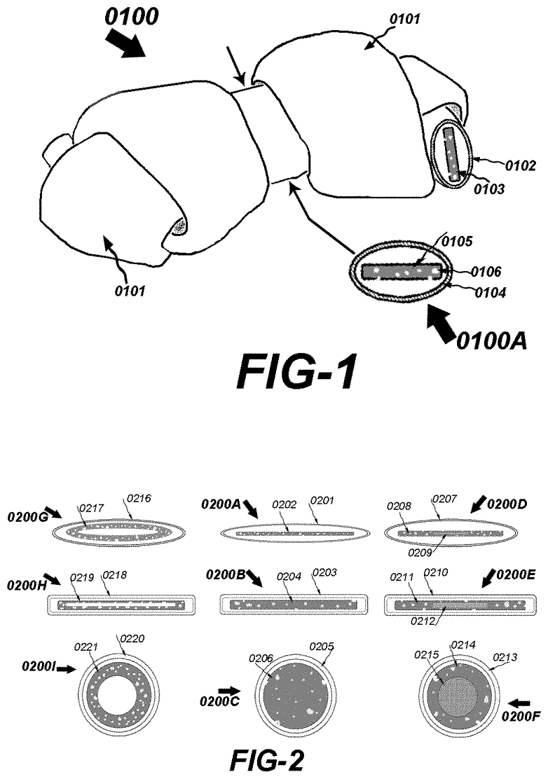

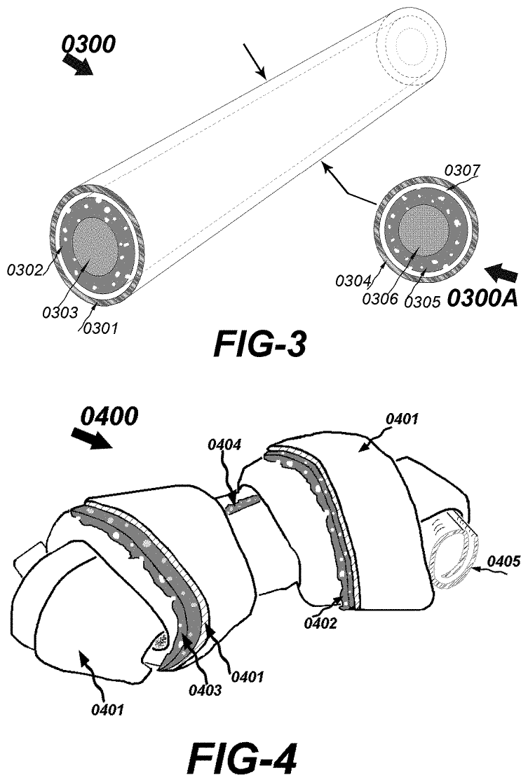

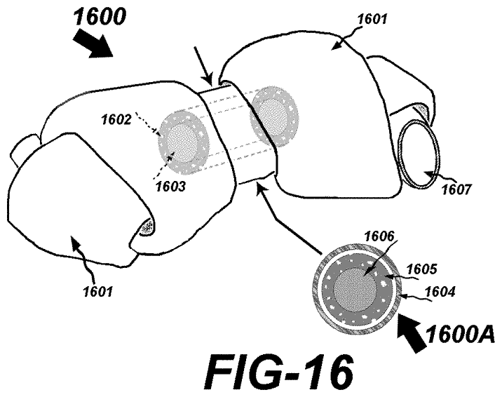

Here comes an aspect of the present disclosure. In this aspect, the edible pet chew includes a first plant based (or animal ingredient based) high density (chewy) tube member/component and a second plant based (or animal ingredient based) low-density (or cellular) material member/component, where the (chewy) tube member/component and the low-density (or cellular) material member/component are assembled together in a relationship. Preferably, the low-density material member/component is wrapped therein by the chewy tube, where at least a portion of the low-density material member/component is completely covered by the chewy tube member/component without exposure. In some embodiments, a finished product developed in this aspect is provided in a form that the first chewy tube member/component serves as the primary exterior surface of the finished product. The plant based (or animal ingredient based) high density chewy tube member/component may imitate at least one quality/characteristic of traditional rawhide sheet (the characteristics may include appearance, surface texture, rigidity, chewy quality, etc.). The chewy tube and the low-density material member/component are separate member/components. The chewy tube and the low-density material member/components are pre-prepared individually rather than by co-extrusion, and later are assembled together. Preferably, both the chewy tube member/component and low-density material member/component is an extruded one being formed by extruder. But it is foreseen that they may be formed by injection process alternatively. Typically, the density of the low-density material member/component ranges from 0.15 g/cm³ to 1 g/cm³. Typical cross section outline shape of the chewy tube is substantially a round, an oval or a rectangle (please refer to the cross section examples 0200A, 0200B and 0200C from FIG. 2), but the outline is not limited to these listed shapes. Typically, the low-density material member/component is in a strip or cylindrical stick or a tube form, with a cross section outline of rectangle, oval or circle. In this aspect of the present disclosure, as an alternative embodiment, a finished product of the edible pet chew may be alternatively in a structure/configuration of knotted bone (referring to FIG. 1 and FIG. 16), cylindrical stick (referring to FIG. 3), twisted sticks, cylindrical roll, candy cane, ball with hollow core and strip as examples. In one embodiment, the proportion of tube member/component to the low-density material member/component is in the approximate range between 1:20 and 30:1 by weight in finished product. In one embodiment, the formulas of the chewy tube member/component and the low-density material member/component may be identical, similar or different. In some embodiments of the present disclosure, the components together forming an edible pet chew are manipulated or shaped (for example by hand) into a final product form such as knotted bone, twist stick, spiral, woven ball with hollow core, roll, braid, ring, candy cane, pretzel knot, etc.

In some embodiments of the present disclosure, an edible pet chew product is provided including a first component of plant/starch based (or animal ingredient based) high density TUBE (pipe) form material and a second component of a cellular plant/starch based (or animal ingredient based) low-density material, in which the second component is in a tube form with hollow core as well.

Now refer to FIG. 1. Edible pet chew of 0100 is an embodiment according to the aforementioned aspect of the present disclosure, in a knotted bone configuration, including a plant/vegetable-based (or animal ingredient based) high density chewy tube member 0102 and a plant based (or animal ingredient based) low-density material member 0103. 0100A refers to the cross section of the pet chew 0100 at the longitudinal middle of the knotted bone, with chewy tube part 0104 and low density part 0105. 0106 refers to an air bubble existing in 0105. 0103 is wrapped by 0102 with ends of 0103 exposed, whose cross-section outline shape resembles a narrow rectangle. 0101 is the exterior surface of chewy tube member 0102. 0102 may be produced by an extruder with a substantially oval shaped extruder die. By adjusting extruder die designs to form chewy tube member 0102 and low-density material member 0103, pet chew 0100 may present different cross section outline configurations as illustrated at 0200A, 0200B, 0200C, 0200G, 0200H and 0200I from FIG. 2. 0200A is identical to 0100A, with oval shaped 0201 and rectangular shaped 0202. 0200B has a rectangular chewy tube member 0203 and a rectangular low-density material member 0204. 0200C includes a round shaped chewy tube member 0205 and a round shaped low-density material member 0206. 0200G is identical to 0100A, with oval shaped 0216 and rectangular tube shaped 0217. 0200H has a rectangular chewy tube member 0218 and a rectangular low-density material tube member 0219. 02001 includes a round shaped chewy tube member 0220 and a circular low density tube material member 0221.

In one embodiment, in this aforementioned aspect of the present disclosure, the edible pet chew further includes a third additional edible material member positioned in the second low-density material member, thus creating a co-extruded composite material combining a low-density material member and an additional edible material member. In one embodiment, the aforementioned composite material combining a low-density material member and an additional edible material member is not a co-extruded one, which is formed by an extruded low-density material (tube) member with a hollow core filled/stuffed with the additional edible material (for example, the additional edible material is a fluid animal ingredient-based slurry material that can be filled/stuffed into the hollow core with pressure). Please refer to FIG. 2, the components, 0217 from 0200G, 0219 from 0200H and 0221 from 02001, are the ones in tube form with hollow cores that may be further filled/stuffed with an additional edible material. Preferably, the third additional edible material member is wrapped about by the low-density material member, in which at least a portion of the additional edible material member is covered by the low-density material member without exposure. Preferably, the edible material member is formed from animal ingredient-based material, or flavored material, or an edible material that is more palatable than the chewy tube member and the low-density material member. Preferably, the edible material member is free of animal hide material or rawhide ingredient. In one embodiment, the edible material member works as a core of the low-density material member, but in one embodiment, a small part of the edible material member may expose without coverage by the low-density material member. some embodiments, each of the 3 members (chewy tube member, low density member and additional edible material member) provide their respectively different functions that can be distinctly defined to the chew product. Preferably, a first chewy tube member primarily provides long time chewing function with its hardness/toughness, a second low density member provides intensified tooth cleaning function with its cellular structure with numerous air bubbles and softness, and a third edible material member provides an important attractant function with strong attractive flavor or animal ingredients. Thus the 3 different functions can be achieved with a single feed. In one embodiment, the third edible material member may provide a new animal nutrition/protein function in addition to the attractant function. In one embodiment, the third edible material member provides the best attractant material of the 3 members to the pet chew, which is significantly more palatable/attractive than the other 2 members. Preferably, the third edible material member is formed from a flavored material or an animal ingredient-based material. In this aspect of the present disclosure, as an alternative embodiment, a finished product of the edible pet chew may be alternatively in a structure/configuration of knotted bone (referring to FIG. 16), cylindrical stick (referring to FIG. 3), twisted sticks, cylindrical roll, candy cane, ball with hollow core and strip as examples. In some embodiments, the inventor arrives at a product that includes a high density chewy tube member and a co-extruded composite material, where the co-extruded composite material combines a low-density material member and an additional edible material member (in one embodiment as a core member), where each of the 3 members (chewy tube member, low density member and additional edible material member) may provide their respectively different functions that can be distinctly defined to the chew product, in which 3 different functions may be provided by a single feed.

According to an alternative embodiment of the present disclosure, a formula of the aforementioned or undermentioned edible material member (animal ingredient-based material member) positioned in the low-density material member includes, by weight on an as formulated basis: 20%-80% frozen meat or dried meat powder, 10%-49.9% plant ingredient, 2%-40% humectants (more typically 10%-30% humectants; humectants such as glycerin, sorbitol). It may be free of animal hide (rawhide) material. It may further include additives such as a colorant (such as FD&C Red 40) and a preservative (such as potassium sorbate). For an instance, an alternative formula is: Frozen Chicken breast (68%), Corn Starch (14%), Isolated soy protein (10%), and Glycerin (8%).

According to an alternative embodiment of the present disclosure, a formula of the aforementioned or undermentioned edible material member (flavored material member) positioned in the low-density material member includes, by weight on an as fed basis: 50%-80% plant material, 2%-40% humectants (more typically 10%-30% humectants; humectants such as glycerin, sorbitol), and 0.1%-30% attractant material (such as dried brewer, dried chicken breast powder, chicken digest, hydrolyzed chicken liver and artificial beef flavor). It may be free of animal hide (rawhide) material. It may further include additives such as a colorant (such as FD&C Red 40) and a preservative (such as potassium sorbate). For an instance, an alternative formula is: Corn Starch (62%), Chicken breast (15%), Hydrolyzed chicken liver (2%), Water (12%) and Glycerin (9%).

Now refer to FIG. 3. Edible pet chew of 0300 is an embodiment according to the present disclosure, in a cylindrical stick shape, including a plant/vegetable-based (or animal ingredient based) high density chewy tube member 0301 and a plant based (or animal ingredient based) low-density material member 0302 with a flavored material or animal ingredient-based material core 0303. 0301 wraps about 0302 with the ends of 0302 exposed. 0300A is a cross section of pet chew 0300. 0304 is the chewy tube member, 0305 is the low-density material member and 0306 is the core member of 0305. 0307 is a space between 0304 and 0305.

The chewy tube member 0301 may be produced by an extruder with a substantially round shaped extruder die. By adjusting extruder die designs to form chewy tube member 0301, low-density material member 0302 and core member 0303, pet chew 0300 may present different cross section outline configurations as illustrated at 0200D, 0200E and 0200F from FIG. 2. 0200F is identical to 0300A, with round/circular shaped 0213, 0214 and 0215. 0200D includes oval shaped chewy tube member 0207, rectangular shaped low-density material member 0208, and rectangular shaped edible material member 0209. 0200E has rectangular shaped chewy tube member 0210, rectangular shaped low-density material member 0211 and rectangular shaped edible material member 0212.

Refer to FIG. 16. Edible pet chew of 1600 is an embodiment according to the present disclosure, in a knotted bone form, including a plant/vegetable-based (or animal ingredient based) high density chewy tube member 1601 and a plant based (or animal ingredient based) low density member 1602 with a flavored material or animal ingredient-based material core 1603. 1601 wraps 1602. 1600A is a cross section of pet chew 1600 at the middle of the diaphysis. 1604 is the chewy tube member, 1605 is the low-density member and 1606 is the core member of 1605. 1607 refers to an end of 1601. 1602 is too short to be visible at the end of 1601.

Here comes another aspect of the present disclosure. In this aspect, the edible pet chew includes a first plant based (or animal ingredient based) high density (chewy) sheet member/component and a second plant based (or animal ingredient based) low-density (or cellular) material member/component, where the (chewy) sheet member/component and the low-density (or cellular) material member/component are assembled together in a relationship. Preferably, the low-density material member/component is wrapped therein by the chewy sheet, where at least a portion of the low-density material member/component is completely covered by the chewy sheet member/component without exposure. In some embodiments, a finished product developed in this aspect is provided in a form that the first chewy sheet member/component serves as the primary exterior surface of the finished product. The plant based (or animal ingredient based) high density chewy sheet member/component may imitate at least one quality/characteristic of traditional rawhide sheet (the characteristics may include appearance, form, shape, surface texture, rigidity, chewy quality, etc.). The chewy sheet member/component and the low-density material member/component are separate member/components. The chewy sheet and low-density material member/components are pre-prepared individually rather than by co-extrusion, and later are assembled together. Preferably, both the chewy sheet member/component and low-density material member/component is an extruded one being formed by extruder. But it is foreseen that they may be formed by injection process alternatively. Typically, the density of the low-density material member/component ranges from 0.15 g/cm³ to 1 g/cm³. A typical cross section outline shape of the chewy sheet is substantially narrow rectangle. Typically, the low-density material member/component is in a thin flat piece, strip, or chunk form. In one embodiment, the proportion of sheet member/component to the low-density material member/component is in the approximate range between 1:20 and 30:1 by weight in finished product. In one embodiment, the formulas of the chewy sheet member/component and the low-density material member/component may be identical, similar or different. In this aspect of the present disclosure, as an alternative embodiment, a finished product of the edible pet chew may be alternatively in a structure/configuration of knotted bone (referring to FIG. 4), cylindrical stick, twisted sticks, cylindrical roll, candy cane, ball with hollow core and strip as examples. In some embodiments of the present disclosure, the components together forming an edible pet chew are manipulated or shaped (for example by hand) into a final product form such as knotted bone, twist stick, spiral, woven ball with hollow core, roll, braid, ring, candy cane, pretzel knot, etc.

In some embodiments of the present disclosure, an edible pet chew product is provided including a first component of plant/starch based (or animal ingredient based) high density SHEET form material and a second component of a cellular plant/starch based (or animal ingredient based) low-density material, in which the second component is in a tube form with hollow core.

Now refer to FIG. 4. Edible pet chew of 0400 is an embodiment according to the aforementioned aspect of the present disclosure, in a knotted bone configuration, including a plant/vegetable-based (or animal ingredient based) high density chewy sheet member 0405 and three plant based (or animal ingredient based) low-density material member 0402, 0403 and 0404. 0402, 0403, 0404 are in a strip form, which are wrapped by 0405 with a portion of them exposed. 0401 is the exterior surface of chewy sheet member 0405. 0405 may be produced by an extruder with a substantially narrow rectangular shaped extruder die to form a sheet configuration.

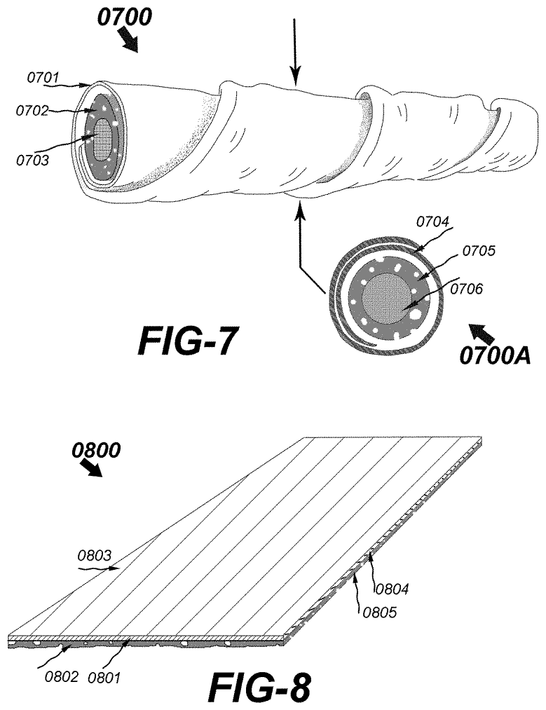

In one embodiment, in the aforementioned aspect of the present disclosure, the edible pet chew further includes a third additional edible material member/component positioned in the second low-density material member/component, thus creating a co-extruded composite material combining a low-density material member/component and an additional edible material member/component. In one embodiment, the aforementioned composite material combining a low-density material member/component and an additional edible material member/component is not a co-extruded one, which is formed by an extruded low-density material member/component with a hollow core filled/stuffed with the additional edible material (for example, the additional edible material is a fluid animal ingredient-based slurry material that can be filled/stuffed into the hollow core with pressure). Preferably, the third additional edible material member/component is wrapped about by the low-density material member/component, in which at least a portion of the additional edible material member/component is covered by the low-density material member/component without exposure. Preferably, the edible material member/component is formed from animal ingredient-based material or rawhide ingredient, or flavored material, or an edible material that is more palatable than the chewy sheet member/component and the low-density material member/component. Preferably, the edible material member/component is free of animal hide material. In one embodiment, the edible material member/component works as a core of the low-density material member/component, but in one embodiment, a small part of the edible material member/component may expose without coverage by the low-density material member/component. Preferably, each of the 3 member/components (chewy sheet member/component, low density member/component and additional edible material member/component) provide their respectively different functions that can be distinctly defined to the chew product. In one embodiment, a first chewy sheet member/component primarily provides long time chewing function with its hardness/toughness, a second low density member/component provides intensified tooth cleaning function with its cellular structure with numerous air bubbles and softness, and a third edible material member/component provides an important attractant function with strong attractive flavor or animal ingredients. Thus the 3 different functions can be achieved with a single feed. In one embodiment, the third edible material member/component may provide a new animal nutrition/protein function in addition to the attractant function. Preferably, the third edible material member provides the best attractant material of the 3 members to the pet chew, which is significantly more palatable/attractive than the other 2 members. In one embodiment, the third edible material member is formed from a flavored material or an animal ingredient-based material. In this aspect of the present disclosure, as an alternative embodiment, a finished product of the edible pet chew may be alternatively in a structure/configuration of knotted bone (referring to FIG. 6), cylindrical stick (referring to FIG. 7), twisted sticks, cylindrical roll, candy cane, ball with hollow core and strip as examples. In some embodiments, the inventor arrives at a product that includes a high density chewy sheet member and a co-extruded composite material including a low-density material member, where the co-extruded composite material combines a low-density material member and an additional edible material member (in one embodiment as a core member), where each of the 3 members (chewy sheet member, low density member and additional edible material member) may provide their respectively different functions that can be distinctly defined to the chew product, in which 3 different functions may be provided by a single feed.

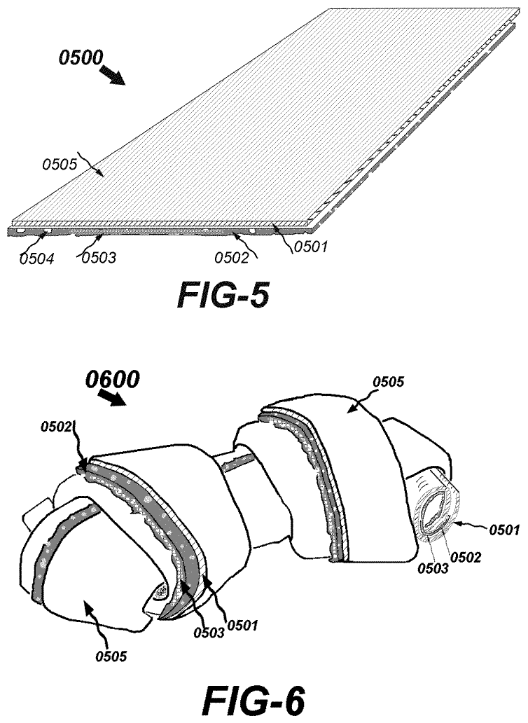

Now refer to FIG. 5. A high density extruded plant based (or animal ingredient based) chewy sheet material 0501 and a co-extruded composite material is prepared, where the co-extruded composite material includes a plant based (or animal ingredient based) low-density material member 0502 and an additional edible material member ix) 0503, in preparation to form edible pet chews of the present disclosure. The additional edible material member 0503 is positioned in 0502, with a cross section outline of substantially rectangle. 0505 refers to exterior surface of 0501. 0504 refers to an air bubble existing in 0502. 0503 works as a core of 0502, which is formed from a meat based material. 0501 and 0502/0503 are now overlapped in a preparation of being further manipulated to form an edible pet chew according to an embodiment of the present disclosure.

Please refer to FIG. 6. Edible pet chew of 0600 is an embodiment according to the present disclosure, in a knotted bone shape, including a high density extruded plant based (or animal ingredient based) chewy sheet member 0501 and a co-extruded composite material including a plant based (or animal ingredient based) low density member 0502 with a core 0503 of flavored material or meat based material member with a substantially-rectangular cross section shape. 0505 is exterior surface of 0501. 0501 and 0502/0503 are assembled together forming alternating layers of the pet chew product, with a portion of 0502 being exposed without coverage.

Please refer to FIG. 7. Edible pet chew of 0700 is an embodiment according to the present disclosure, in a twisted stick shape, including a high density extruded vegetable-based (or animal ingredient based) chewy sheet member 0701 and a co-extruded composite material including a vegetable-based (or animal ingredient based) low density cylindrical stick member 0702 with an animal ingredient-based material core member 0703 with a round cross section shape. 0701 wraps about 0702, with the ends of 0702 being exposed. 0700A is a cross section of pet chew 0700. 0704 is the chewy sheet member, 0705 is the low-density material member and 0706 is the core member.

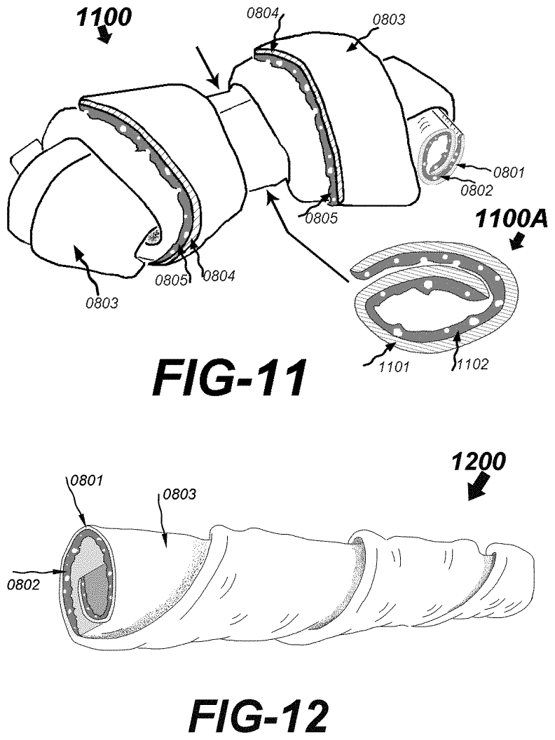

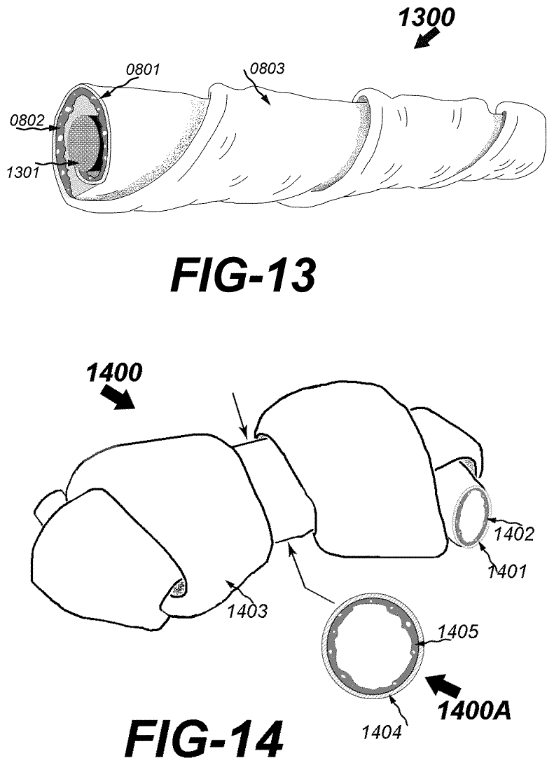

Here comes another aspect of the present disclosure. In this aspect, the edible pet chew includes a co-extruded “plural-layer-structured sheet” member, which includes/combines a first layer (portion) of plant based (or animal ingredient based) high density (chewy) sheet material and a second layer (portion) of plant based (or animal ingredient based) low-density (or cellular) material. The co-extruded “plural-layer-structured sheet” member may be manipulated (such as folding, knotting, twisting, rolling, wrapping) and hardened to the final form of a finished product. Preferably, a finished product developed in this aspect is provided in a form that the first layer portion serves as the primary exterior surface of the finished product. Preferably, the first layer is with satisfied rigidity/hardness and/or toughness which can endure a dog's long time gnawing/chewing activity before being swallowed. The first layer may imitate at least one quality/characteristic of traditional rawhide sheet (such as appearance, form, shape, surface texture, rigidity, chewy quality, etc.). In one embodiment, the chewy function of the edible pet chew product is substantially or primarily fulfilled by the first layer portion. Preferably, the “plural-layer-structured sheet” member is an extruded one being formed by extruder. But it is foreseen that it may be formed by injection process alternatively. Preferably, the average thickness of the second low density portion is larger than that of the first chewy sheet portion. Typically, the density of the low-density material ranges from 0.15 g/cm³ to 1 g/cm³. A typical cross section outline shape of the firstly layer is substantially narrow rectangle. In one embodiment, the proportion of first layer to the second one is in an approximate range between 1:20 and 20:1 by weight in finished product. In one embodiment, the formulas of the chewy sheet layer portion and the low density layer portion may be identical, similar or different. In this aspect of the present disclosure, as an alternative embodiment, a finished product of the edible pet chew may be alternatively in a structure/configuration of knotted bone (referring to FIG. 11), cylindrical stick, twisted sticks (FIG. 12 and FIG. 13), cylindrical roll, candy cane, ball with hollow core and strip as examples.

Preferably, after co-extrusion process, the first layer portion and the second one attach to each other firmly as a whole, which cannot be separated easily with hands. The first layer portion and the second one form integral parts of the co-extruded “plural-layer-structured sheet” material, in which the first portion and the second portion are not separate ones. This product may have following advantages. A), The efforts to combine plural layer portions (portions may be formed from different materials) in a single piece and to have them inseparable significantly can ensure that dog teeth subsequently reach the second low density layer portion after penetrating the first chewy sheet layer portion, in a single chewing run. Thus, double effects of teeth grinding and cleaning are enhanced. B), In comparison to individually extruded process to produce two independent layers of chewy sheet and low-density material member, a single whole piece combining a first layer of chewy sheet and a second layer of low-density material generated by co-extrusion process enjoys higher production efficiency and lower labor cost. C), The product provides an appealing layering effect welcome by consumers. The aforementioned features and benefits of edible pet chews formed from the co-extruded “plural-layer-structured sheet” material may also apply to the undermentioned edible pet chews formed from a co-extruded “plural-layer-structured” tube material. In some embodiments, the inventor arrives at a product that includes a plural-layer-structured material combining/integrating a high density chewy sheet layer portion and a low density layer portion, which may be realized by a process, which may involve adjustment to existing regular co-extrusion process. The co-extrusion adjustment involves a combination of two different extrusion machines, one of which is for producing high density chewy sheet items and the other of which is for producing low density items. Further, they are not able to obviously anticipate the availability of the integration of the two different portion materials, a high density chewy sheet portion and a low density layer portion.

Now refer to FIG. 8. A piece of co-extruded “plural-layer-structured sheet” member 0800 is prepared, in preparation of being further manipulated to form edible pet chews according to an embodiment of the present disclosure. 0800 has two layers, one of which is a plant based (or animal ingredient based) high density chewy sheet 0801, the other one of which is a plant based (or animal ingredient based) low-density material 0802. 0802 is joined to 0801 firmly and tightly. 0800 may be obtained by cutting from a very long extruded material being constantly produced by an extruder. 0801 and 0802 also refer to a latitudinal side of the two layer portions, and 0804 and 0805 do a longitudinal one. 0803 refers to exterior surface of the first layer portion 0801.

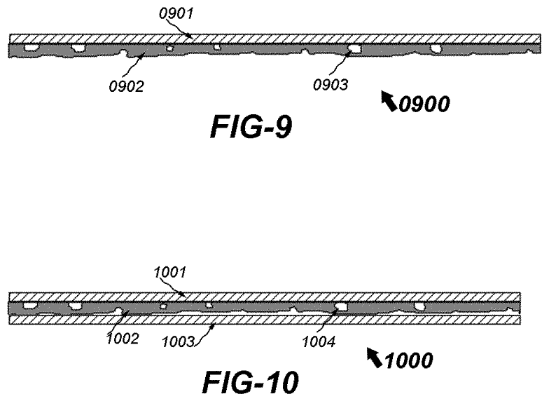

Please refer to FIG. 9. 0900 is a latitudinal cross section view of co-extruded “plural-layer-structured sheet” member 0800 from FIG. 8. 0901 refers to a first layer of plant based (or animal ingredient based) high density chewy sheet material, and 0902 does a second layer of plant based (or animal ingredient based) low-density material. 0903 refers to an air bubble existing in 0902. 0901 and 0902 attach to each other firmly.

In FIG. 10, a piece of co-extruded triple layered sheet member 1000 is prepared, in preparation of being further manipulated to form edible pet chews according to an embodiment of the present disclosure, including a first layer 1001, a second layer 1002 and a third layer 1003. FIG. 10 reflects a cross section view. In comparison to 0900 from FIG. 9, 1000 additionally includes a third layer of plant based (or animal ingredient based) high density chewy sheet, creating a sandwich-like configured item. Both 1001 and 1003 are formed from plant based (or animal ingredient based) high density chewy sheet material, being joined to 1002 firmly. 1002 is formed from a plant based (or animal ingredient based) low-density material, with numerous air bubbles throughout it including air bubble 1004.

Please refer to FIG. 11. Edible pet chew of 1100 is an embodiment according to the present disclosure, in a knotted bone shape, including a two-layered “plural-layer-structured sheet” member 0800 from FIG. 8, with a first layer of plant based (or animal ingredient based) high density chewy sheet 0801 and a second layer of plant based (or animal ingredient based) low-density material 0802. 0803 is the exterior surface of 0801. 0804 and 0805 refer to longitudinal sides of layer 0801 and 0802 respectively. The first layer 0801 serves as the primary exterior surface of the finished product. 1100A is a cross section view of 1100. 1101 refers to a cross section view of the first layer of plant based (or animal ingredient based) high density chewy sheet 0801 and 1102 does a cross section view of the second layer of plant based (or animal ingredient based) low-density material 0802.

Please refer to FIG. 12. Edible pet chew of 1200 is an embodiment according to the present disclosure, in a twisted stick configuration, including a two-layered “plural-layer-structured sheet” member 0800 from FIG. 8, with a first layer of plant based (or animal ingredient based) high density chewy sheet 0801 and a second layer of plant based (or animal ingredient based) low-density material 0802. 0803 is the exterior surface of 0801. The first layer 0801 serves as the primary exterior surface of the finished product.

In one embodiment, in the aforementioned aspect of the present disclosure, the edible pet chew further includes an additional edible material member being wrapped about by the “plural-layer-structured sheet” member, thus creating an edible pet chew combining a first co-extruded “plural-layer-structured sheet” member and a second edible material member, where the first co-extruded “plural-layer-structured sheet” member includes a first plant based material (or animal ingredient based) high density chewy sheet layer portion and a second plant based (or animal ingredient based) low density layer portion. Preferably, the edible material member is formed from animal ingredient-based material, or flavored material, or an edible material that is more palatable than the chewy sheet portion and the low-density material portion. Preferably, the edible material member is free of animal hide material or rawhide ingredient. Preferably, the edible material member works as an interior member of the edible pet chew, but in one embodiment, a small part of the edible material member may expose without coverage by the co-extruded “plural-layer-structured sheet” member. Preferably, each of the 3 members/portions (a first high density chewy sheet layer portion, a second low density layer portion and a third edible material member) provides their respectively different functions that can be distinctly defined to the chew product. In one embodiment, a plant based (or animal ingredient based) high density chewy sheet layer portion primarily provides long time chewing function with its hardness/toughness, a second plant based (or animal ingredient based) low density layer portion provides intensified tooth cleaning function with its cellular structure with numerous air filled cavities and softness, and a third edible material member provides an important attractant function with strong attractive flavor or animal ingredients. Thus the 3 different functions can be achieved with a single feed. In one embodiment, the third edible material member may provide a new animal nutrition/protein function in addition to the attractant function. Preferably, the third edible material member provides the best attractant material of the 3 members/portions to the pet chew, which is significantly more palatable/attractive than the other 2 members/portions. In one embodiment, the third edible material member is formed from a flavored material or an animal ingredient-based material. In this aspect of the present disclosure, as an alternative embodiment, a finished product of the edible pet chew may be alternatively in a structure/configuration of knotted bone, cylindrical stick, twisted sticks (referring to FIG. 13), cylindrical roll, candy cane, ball with hollow core and strip as examples. In some embodiments, three different portions (a first chewy sheet layer portion, a second low density portion and a third edible material portion) of a pet chew may be co-extruded by a single extrusion run involving three individual extrusion machines to support the co-extrusion process.

Now refer to FIG. 13. Edible pet chew of 1300 is an embodiment according to the present disclosure, in a twisted stick configuration, including a first two-layered “plural-layer-structured sheet” member 0800 from FIG. 8 and a second edible material member 1301 in cylindrical stick form. 0800 wraps about 1301 with a part of 1301 exposed. 0800 has a first layer of plant based (or animal ingredient based) high density chewy sheet 0801 and a second layer of plant based (or animal ingredient based) low-density material 0802. 0803 is the exterior surface of 0801. The first layer 0801 serves as the primary exterior surface of the finished product.

Here comes another aspect of the present disclosure. In this aspect, the edible pet chew includes a co-extruded plural-layer-structured tube member, which includes/combines a first layer (portion) of plant based (or animal ingredient based) high density (chewy) tube and a second layer (portion) of plant based (or animal ingredient based) low-density (or cellular) material. The co-extruded plural-layer-structured tube member may be manipulated (such as folding, knotting, twisting, rolling, wrapping) and hardened to the final form of a finished product. Preferably, a finished product developed in this aspect is provided in a form that the first layer portion serves as the primary exterior surface of the finished product. Preferably, the first layer is with satisfied rigidity/hardness and/or toughness which can endure a dog's long time gnawing/chewing activity before being swallowed. The first layer may imitate at least one quality/characteristic of traditional rawhide sheet (such as appearance, surface texture, rigidity, chewy quality). In one embodiment, the chewy function of the edible pet chew product is substantially or primarily fulfilled by the first layer portion. Preferably, the plural-layer-structured tube member is an extruded one being formed by extruder. But it is foreseen that it may be formed by injection process alternatively. Typically, the density of the low-density material ranges from 0.15 g/cm³ to 1 g/cm³. A typical cross section outline shape of the firstly layer is substantially round, oval or rectangular. In one embodiment, the proportion of first layer to the second one is in an approximate range between 1:20 and 20:1 by weight in finished product. In one embodiment, the formulas of the chewy tube layer and the low density layer may be identical, similar or different. In this aspect of the present disclosure, as an alternative embodiment, a finished product of the edible pet chew may be alternatively in a structure/configuration of knotted bone (referring to FIG. 14), cylindrical stick, twisted sticks, cylindrical roll, candy cane, ball with hollow core and strip as examples. In one embodiment, after co-extrusion process, the first layer portion and the second one attach to each other firmly as a whole, which cannot be separated easily with hands. The first layer portion and the second one form integral parts of the co-extruded plural-layer-structured tube material, in which the first portion and the second portion are not separate ones.

Now refer to FIG. 14. Edible pet chew of 1400 is an embodiment according to the present disclosure, in a knotted bone shape, including a two-layer-structured tube member, with a first layer of plant based (or animal ingredient based) high density chewy tube 1401 and a second layer of plant based (or animal ingredient based) low-density material 1402. 1403 is the exterior surface of 1401. The first layer 1401 serves as the primary exterior surface of the finished product. 1400A is a cross section view of 1400. 1404 refers to a cross section view of the first layer of plant based (or animal ingredient based) high density chewy tube 1401 and 1405 does a cross section view of the second layer of plant based (or animal ingredient based) low-density material 1402.

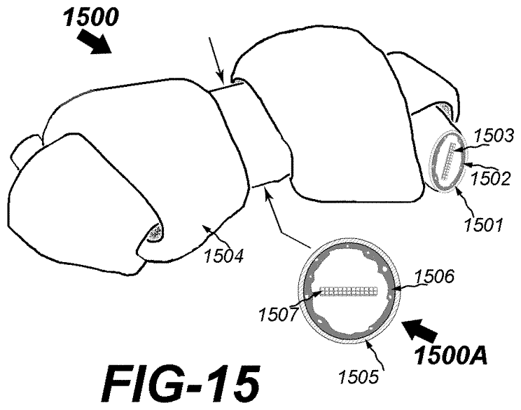

In one embodiment, in the aforementioned aspect of the present disclosure, the edible pet chew further includes an additional edible material member being wrapped about by the plural-layer-structured tube member, thus creating an edible pet chew combining a first co-extruded plural-layer-structured tube member and a second edible material member, where the first co-extruded plural-layer-structured tube member includes a first plant based (or animal ingredient based) material high density chewy tube layer portion and a second plant based (or animal ingredient based) low density layer portion. Preferably, the edible material member is formed from animal ingredient-based material, or flavored material, or an edible material that is more palatable than the chewy tube portion and the low-density material portion. Preferably, the edible material member is free of animal hide material or rawhide ingredient. Preferably, the edible material member works as an interior member of the edible pet chew, but in one embodiment, a small part of the edible material member may expose without coverage by the co-extruded plural-layer-structured tube member. Preferably, each of the 3 members/portions (a first high-density chewy tube layer portion, a second low density layer portion and a third edible material member) provide their respectively different functions that can be distinctly defined to the chew product. In one embodiment, a plant based (or animal ingredient based) high density chewy tube layer portion primarily provides long time chewing function with its hardness/toughness, a second plant based (or animal ingredient based) low density layer portion provides intensified tooth cleaning function with its cellular structure with numerous air bubbles and softness, and a third edible material member provides an important attractant function with strong attractive flavor or animal ingredients. Thus the 3 different functions can be achieved with a single feed. In one embodiment, the third edible material member may provide a new animal nutrition/protein function in addition to the attractant function. Preferably, the third edible material member provides the best attractant material of the 3 members/portions to the pet chew, which is significantly more palatable/attractive than the other 2 members/portions. In one embodiment, the third edible material member is formed from a flavored material or an animal ingredient-based material. In this aspect of the present disclosure, as an alternative embodiment, a finished product of the edible pet chew may be alternatively in a structure/configuration of knotted bone (referring to FIG. 15), cylindrical stick, twisted sticks, cylindrical roll, candy cane, ball with hollow core and strip as examples. In some embodiments, three different portions (a first chewy tube layer portion, a second low density portion and a third edible material portion) of a pet chew may be co-extruded by a single extrusion run involving three individual extrusion machines to support the co-extrusion process.

Now refer to FIG. 15. Edible pet chew of 1500 is an embodiment according to the present disclosure, in a knotted bone configuration, including a first two-layer-structured tube member and a second edible material member 1503 in a strip form with narrow rectangle cross section outline shape. The first tube member wraps about 1503 with a part of 1503 exposed. The first tube member has a first layer of plant based (or animal ingredient based) high density chewy tube 1501 and a second layer of plant based (or animal ingredient based) low-density material 1502. 1504 is the exterior surface of 1501. The first layer 1501 serves as the primary exterior surface of the finished product. 1500A is a cross section view of 1500. 1505 refers to a cross section view of the first layer of plant based (or animal ingredient based) high density chewy tube 1501 and 1506 does a cross section view of the second layer of plant based (or animal ingredient based) low-density material 1502. 1507 refers to a cross section view of the edible material member 1503.

In another aspect of the present disclosure, an edible pet chew is provided combining/including a first component of bar-shaped plant/starch based (or animal ingredient based) high density (or strip-shaped) material and a second component of a plant/starch based (or animal ingredient based) low-density material, which are assembled together in a relationship. The chewy function of the edible pet chew product is substantially or primarily fulfilled by the component of bar-shaped material. Generally, the term of “bar” refers to a material of long roughly-rectangular piece in a considerable thickness whose cross section is in a shape of a rough rectangle.

In another aspect of the present disclosure, an edible pet chew is provided combining/including a component of bar-shaped (or strip-shaped) material. The bar-shaped (or strip-shaped) material includes a first portion formed from plant/starch based (or animal ingredient based) high-density material and a second portion formed from plant/starch based (or animal ingredient based) low density material. Preferably, the first high density portion and the second low density portion run longitudinally through the full length of the bar-shaped material side by side by length, where the first high density portion and the second low density portion have a roughly same thickness. The bar-shaped material may be manipulated (for example by hand) into the final shape of the final product, where the final shape may be knotted bone, twist stick, spiral, etc.

According to an alternative embodiment of the present disclosure, a plant based formula for the chewy tube or chewy sheet members/portions (such as 0102 from FIG. 1, 0301 from FIG. 3, 0401 from FIG. 4, 0501 from FIGS. 5 and 6, 0701 from FIG. 7, 0801 from FIG. 8, FIG. 11, FIG. 12 and FIG. 13, 1003 from FIG. 10, 1401 from FIGS. 14 and 1501 from FIG. 15) includes, by weight on an as fed basis (this formula may also apply to the low density member/portion, such as 0103 from FIG. 1, 0302 from FIG. 3, 0402 from FIG. 4, 0502 from FIGS. 5 and 6, 0702 from FIG. 7, 0802 from FIG. 8, FIG. 11, FIG. 12 and FIG. 13, 1002 from FIG. 10, 1402 from FIGS. 14 and 1502 from FIG. 15): 20%-80% plant material, 2%-40% humectants (more typically 10%-30% humectants; humectants such as glycerin, sorbitol). It may be free of animal hide (rawhide) material. It may further include additives such as an attractant (such as dried brewer, hydrolyzed chicken liver), a colorant (such as titanium dioxide) and a preservative (such as potassium sorbate). The formula is a plant based material one. For an instance, an alternative formula is: Potato Starch (69%), Chicken breast (8%), Water (12%) and Glycerin (11%).

According to an alternative embodiment of the present disclosure, a formula for the chewy tube or chewy sheet members/portions (such as 0102 from FIG. 1, 0301 from FIG. 3, 0401 from FIG. 4, 0501 from FIGS. 5 and 6, 0701 from FIG. 7, 0801 from FIG. 8, FIG. 11, FIG. 12 and FIG. 13, 1003 from FIG. 10, 1401 from FIGS. 14 and 1501 from FIG. 15) includes (this formula may also apply to the low density member/portion, such as 0103 from FIG. 1, 0302 from FIG. 3, 0402 from FIG. 4, 0502 from FIGS. 5 and 6, 0702 from FIG. 7, 0802 from FIG. 8, FIG. 11, FIG. 12 and FIG. 13, 1002 from FIG. 10, 1402 from FIGS. 14 and 1502 from FIG. 15): 10%-50% animal ingredient(s), 30%-49.9% plant material, 2%-40% humectants (more typically 10%-30% humectants; humectants such as glycerin, sorbitol). It may be free of animal hide (rawhide) material. It may further include additives such as an attractant (such as dried brewer, hydrolyzed chicken liver), a colorant (such as titanium dioxide) and a preservative (such as potassium sorbate). The formula is an animal ingredient-based material one. For an instance, an alternative formula is: Frozen Chicken Breast (24%), Corn Starch (49%), Cattle Bone Powder (5%), beef liver (3%) and Glycerin (19%).

The humectant may be selected from the group consisting of: plant protein isolate, soy protein Isolate, wheat protein isolate, corn protein isolate, glucose syrup, malt syrup, sodium pyrophosphate, trisodium orthophosphate, sodium hexametaphosphate, sodium tripolyphosphate, phosphoric acid, calcium dihydrogen phosphate, sodium lactate, maltitol, sorbitol, propylene glycol, glycerin, sodium dihydrogen phosphate, sodium phosphate dibasic, potassium lactate, sodium lactate, acetylated distarch phosphate and acetylated distarch adipate.

According to an alternative embodiment of the present disclosure, a formula for the aforementioned chewy tube or chewy sheet members/portions includes, by weight on an as fed basis (this formula may also apply to the low density member/portion): 50%-80% plant material, 2%-40% humectants (more typically 10%-30% humectants; humectants such as glycerin, sorbitol), 0.1%-20% animal ingredient (such as poultry digest, chicken liver, chicken meal, chicken breast powder, fish, bone powder). The formula is a plant-based material one. For an instance, an alternative formula is: Tapioca (50%), Wheat starch (19%), Water (13%), Soybean protein (8%), Pork (5%), Sorbitol (3%) and Xanthan gum (2%).

According to an alternative embodiment of the present disclosure, a formula for the aforementioned chewy tube or chewy sheet members/portions includes, by weight on an as fed basis (this formula may also apply to the low density member/portion): 15%-70% plant starch material, 2%-20% plant protein material, 2%-40% humectants (more typically 10%-30% humectants; humectants such as glycerin, sorbitol), 0.1%-20% animal ingredient (such as poultry digest, chicken liver, chicken meal, chicken breast powder, fish), 0.1%-8% dried brewer yeast. For an instance, an alternative formula is: Sweet potato (52.7%), Potato starch (10%), Isolated pea protein (10%), Chicken breast powder (5%), Cattle liver powder (1%), Fructose (3%), Gelatin (2%), Bone powder (3%), Water (12%), Dried brewer yeast (1%), Sodium pyrophosphate (0.3%).

According to an alternative embodiment of the present disclosure, a formula for the aforementioned chewy tube or chewy sheet members/portions includes, by weight (this formula may also apply to the low density member/portion): 10%-40% animal ingredient (such as poultry digest, chicken liver, chicken meal, chicken breast powder, fish, bone powder), 20%-49.9% plant material, 2%-40% humectants (more typically 10%-30% humectants; humectants such as glycerin, sorbitol). The formula is an animal ingredient-based material one. For an instance, an alternative formula is: Frozen chicken breast (36%), Potato (20%), Wheat starch (13%), Water (13%), Soybean protein (8%), Sorbitol (8%) and Xanthan gum (2%).

In an embodiment, the present disclosure provides a method of making a plant based (or animal ingredient based) high density chewy sheet or chewy tube member (the member examples such as 0102 from FIG. 1, 0301 from FIG. 3, 0401 from FIG. 4, 0501 from FIGS. 6 and 0701 from FIG. 7) of an edible pet chew of the present disclosure. The method comprises the steps of: i, Raw material storage; ii, Grinding; iii, Mixing; iv, Material feeding; v, Pelletizing (alternative); vi, Extruding (single screw extruder may be employed herein).

In the aforementioned pelletizing step, starch materials may get pre-gelatinized. Temperature profile along the extruder barrel may be, for example: Zone 1, 80-100° C.; Zone 2, 100-140° C.; Zone 3, 100-140° C.; Zone 4, 100-140° C.; Zone 5, 100-140° C.; Zone 6, 100-130° C.; Zone 7, 100-125° C.; Zone 8, 90-100° C.; Zone 9, 85-110° C.; Zone 10, 60-90° C. Material feeding speed: 40-80 HZ. Screw rotational speed: 100-300 HZ.

In the aforementioned extruding step (single screw extruder), the sheet or tube formed material is shaped therein. Temperature profile along the extruder barrel may be, for example: Zone 1, 50-70° C.; Zone 2, 70-110° C.; Zone 3, 70-110° C.; Zone 4, 70-100° C. Material feeding speed: 10-20 HZ. Screw rotational speed: 15-40 HZ.

In another embodiment, the present disclosure provides a method of making a plant based (or animal ingredient based) low-density material member (the member examples such as 0103 from FIG. 1, 0302 from FIG. 3, 0402 from FIG. 4, 0502 from FIGS. 5 and 0702 from FIG. 7) an edible pet chew of the present disclosure. The method comprises the steps of: i, Raw material storage; ii, Grinding; iii, Mixing; iv, Material feeding; v, Extruding (twin screw extruder may be employed herein).

In the aforementioned extruding step (twin screw extruder), the low-density material member is shaped therein. Temperature profile along the extruder barrel may be, for example: Zone 1, 60-80° C.; Zone 2, 100-150° C.; Zone 3, 100-150° C.

In another embodiment, the present disclosure provides a method of making a co-extruded “plural-layer-structured sheet” (or tube) member (the co-extruded member examples such as 0801+0802 from FIG. 8 and FIG. 11, FIG. 12 and FIG. 13, 1401+1402 from FIGS. 14 and 1501+1502 from FIG. 15) combining a first layer (portion) of plant based (or animal ingredient based) high density chewy sheet (or tube) and a second layer (portion) of plant based (or animal ingredient based) low-density material of an edible pet chew of the present disclosure. The method comprises the steps of (Extruder I and II are assembled together to establish a co-extruder. The undermentioned Step A and B are completed simultaneously as a preparation for next co-extrusion step):

Step A, Forming a plant based (or animal ingredient based) high density chewy sheet (or tube) layer portion with Extruder I, including: i, Raw material storage; ii, Grinding; iii, Mixing; iv, Pelletizing (alternative); v, Extruding (single screw extruder may be employed herein).

Step B, Forming a plant based (or animal ingredient based) low-density material layer portion with Extruder II, including: i, Raw material storage; ii, Grinding; iii, Mixing; iv, Extruding (twin screw extruder may be employed herein).

Step C, Co-extruding.

In addition, to produce an embodiment of edible pet chew of the present disclosure, following steps may be taken as soon as the aforementioned co-extruded product member (the co-extruded member examples such as 0801+0802 from FIG. 8 and FIG. 11, FIG. 12 and FIG. 13, 1401+1402 from FIGS. 14 and 1501+1502 from FIG. 15) is ready: i. assemble an additional product member with the co-extruded member together in a pre-determined relationship (alternative); ii, manipulated to the shape or structure of finished product; iii, drying by heat treatment, final finished product moisture less than 25% (typical moisture range such as 8%-18%); iv, packaging.

What is claimed is:

1. An edible pet chew, comprising:
a cellular material component, wherein said cellular material component comprises numerous air bubbles interspersed into the material; and
an extruded high-density tube component, wherein said extruded high-density tube component and said cellular material component are assembled together in a predetermined relationship.

2. The edible pet chew, as recited in claim 1, wherein
said extruded high-density tube component is an extruded plant-based high-density tube component, wherein said cellular material component is an extruded cellular plant-based low-density material component, wherein a bulk density of said extruded plant-based high-density tube component is at least 10% larger than that of said extruded cellular plant-based low-density material component.

3. The edible pet chew, as recited in claim 2, wherein
said extruded plant-based high-density tube component comprises substantially at least 50% plant ingredient by weight, wherein said extruded cellular plant-based low-density material component comprises substantially at least 50% plant ingredient by weight, wherein said extruded plant-based high-density tube component is free of rawhide in formula, and wherein said extruded cellular plant-based low-density material member is free of rawhide in formula.

4. The edible pet chew, as recited in claim 1, wherein
said extruded high-density tube component is an extruded animal-ingredient-based high-density tube component, wherein said cellular material component is an extruded cellular low-density material component, wherein a bulk density of said extruded animal-ingredient-based high-density tube component is at least 10% larger than that of said extruded cellular low-density material component, wherein said extruded animal-ingredient-based high-density tube component comprises substantially at least 10% animal ingredient and 5%-49.9% plant ingredient by weight, and wherein said extruded animal-ingredient-based high-density tube component is free of rawhide ingredient.

5. The edible pet chew, as recited in claim 1, wherein
said cellular material component is an extruded cellular animal-ingredient-based low-density material component, wherein a bulk density of said extruded high-density tube component is at least 10% larger than that of said extruded cellular animal-ingredient-based low-density material component, wherein said extruded cellular animal-ingredient-based low-density material component comprises substantially at least 10% animal ingredient and 5%-49.9% plant ingredient by weight, and wherein said extruded cellular animal-ingredient-based low-density component is free of rawhide ingredient.

6. The edible pet chew, as recited in claim 2, wherein
said extruded plant-based high-density tube component is an extruded plant-based high-density CHEWY tube component, wherein a wall thickness of said extruded plant-based high-density chewy tube component is substantially homogeneous throughout the material, wherein a bulk density of said extruded plant-based high-density chewy tube component ranges from 0.8 g/cm³ to 2 g/cm³, and wherein a bulk density of said extruded cellular plant-based low-density material component ranges from 0.15 g/cm³ to 1 g/cm³.

7. The edible pet chew, as recited in claim 6, wherein
said extruded plant-based high-density chewy tube component is formed from a first starch-based composite, wherein said first starch-based composite comprises a starch ingredient and a humectant ingredient, wherein said starch ingredient of said first starch-based composite is selected from the group consisting of: potato starch, sweet potato starch, mung bean starch, wheat starch, corn starch, tapioca starch, rice starch and pea starch, wherein
said extruded cellular plant-based low-density material component is formed from a second starch-based composite, wherein said second starch-based composite comprises a starch ingredient and a humectant ingredient, and wherein said starch ingredient of said second starch-based composite is selected from the group consisting of: potato starch, sweet potato starch, mung bean starch, wheat starch, corn starch, tapioca starch, rice starch and pea starch.

8. The edible pet chew, as recited in claim 2, wherein
said extruded cellular plant-based low-density material component is wrapped about by said extruded plant-based high-density tube component, wherein at least a portion of said extruded cellular plant-based low-density material component is covered by said extruded plant-based high-density tube component without exposure, wherein the proportion of said extruded plant-based high-density tube component to said extruded cellular plant-based low-density material component is in the range between 1:20 and 30:1 by weight in finished product, wherein cross section outline shape of said extruded plant-based high-density tube component is selected from the group consisting of: a round shape, an oval shape, a rectangular shape, a shape resembling arabic numerals “8” forming a twin-tube form, and wherein the average wall thickness of said extruded plant-based high-density tube component ranges from 0.3 mm to 10 mm.

9. The edible pet chew, as recited in claim 1, wherein
said extruded high density tube member and said cellular material member attach to each other firmly by a co-extrusion process, wherein said extruded high density tube member forms a first layer portion, wherein said cellular material member forms a second layer portion.

10. The edible pet chew, as recited in claim 9, wherein
said first layer of extruded high density tube material forms primary exterior surface of finished product, wherein the proportion of said first layer of extruded high density tube material to said second layer of cellular material is in the range between 1:20 and 20:1 by weight in finished product, wherein cross section outline shape of said first layer of extruded high density tube material is selected from the group consisting of: a round shape, an oval shape, a rectangular shape, a shape resembling arabic numerals “8” forming a twin-tube form, and wherein an average wall thickness of said first layer of extruded high density tube member ranges from 0.3 mm to 10 mm.

11. The edible pet chew, as recited in claim 1, further comprising:
an edible material component, wherein said edible material component is wrapped about by said cellular material component, wherein at least a portion of said edible material component is covered by said cellular material component without exposure, wherein said extruded high density tube component is an extruded plant-based high density tube component, wherein said cellular material component is an extruded cellular plant-based low density material component, and wherein each of said extruded plant based high-density tube component, said extruded cellular plant-based low density material component and said edible material component provides their respectively different function to final product.

12. The edible pet chew, as recited in claim 11, wherein
said edible material component is formed from an animal-ingredient-based material or a flavored material, wherein said animal-ingredient-based material comprises substantially at least 10% animal ingredient by weight, wherein a total animal ingredient proportion by weight existing in said animal-ingredient-based material is greater than any single non-animal ingredient, wherein said flavored material is a plant-based material comprising a plant ingredient and a flavor ingredient, and wherein said flavor ingredient is selected from the group consisting of: a meat ingredient, a meat by-products ingredient, a chicken liver, a hydrolyzed animal protein, a poultry digest, a chicken digest, an artificial beef flavor, an artificial pork flavor and a brewer yeast.

13. The edible pet chew, as recited in claim 1, wherein
said cellular material component and said extruded high-density tube material component are separate components to form a final product of said edible pet chew together.

14. An edible pet chew, comprising:
a cellular material component, wherein said cellular material component comprises numerous air bubbles interspersed into the material; and
an extruded high-density sheet component, wherein said extruded high-density sheet component and said cellular material component are assembled together in a predetermined relationship.

15. The edible pet chew, as recited in claim 14, wherein
said extruded high-density sheet component is an extruded plant-based high-density sheet component, wherein said cellular material component is an extruded cellular plant-based low-density material component, wherein a bulk density of said extruded plant-based high-density sheet component is at least 10% larger than that of said extruded cellular plant-based low-density material component.

16. The edible pet chew, as recited in claim 15, wherein
said extruded plant-based high-density sheet component comprises substantially at least 50% plant ingredient by weight, wherein said extruded cellular plant-based low-density material component comprises substantially at least 50% plant ingredient by weight, wherein said extruded plant-based high-density sheet component is free of rawhide in formula, and wherein said extruded cellular plant-based low-density material member is free of rawhide in formula.

17. The edible pet chew, as recited in claim 14, wherein
said extruded high-density sheet component is an extruded animal-ingredient-based high-density sheet component, wherein said cellular material component is an extruded cellular low-density material component, wherein a bulk density of said extruded animal-ingredient-based high-density sheet component is at least 10% larger than that of said extruded cellular low-density material component, wherein said extruded animal-ingredient-based high-density sheet component comprises substantially at least 10% animal ingredient and 5%-49.9% plant ingredient by weight, and wherein said extruded animal-ingredient-based high-density sheet component is free of rawhide ingredient.

18. The edible pet chew, as recited in claim 14, wherein
said cellular material component is an extruded cellular animal-ingredient-based low-density material component, wherein a bulk density of said extruded high-density sheet component is at least 10% larger than that of said extruded cellular animal-ingredient-based low-density material component, wherein said extruded cellular animal-ingredient-based low-density material component comprises substantially at least 10% animal ingredient and 5%-49.9% plant ingredient by weight, and wherein said extruded cellular animal-ingredient-based low-density component is free of rawhide ingredient.

19. The edible pet chew, as recited in claim 15, wherein
said extruded plant-based high-density sheet component is an extruded plant-based high-density CHEWY sheet component, wherein a thickness of said extruded plant-based high-density chewy sheet component is substantially homogeneous throughout the material, wherein a bulk density of said extruded plant-based high-density chewy sheet component ranges from 0.8 g/cm³ to 2 g/cm³, and wherein a bulk density of said extruded cellular plant-based low-density material component ranges from 0.15 g/cm³ to 1 g/cm³.

20. The edible pet chew, as recited in claim 19, wherein
said extruded plant-based high-density chewy sheet component is formed from a first starch-based composite, wherein said first starch-based composite comprises a starch ingredient and a humectant ingredient, wherein said starch ingredient of said first starch-based composite is selected from the group consisting of: potato starch, sweet potato starch, mung bean starch, wheat starch, corn starch, tapioca starch, rice starch and pea starch, wherein
said extruded cellular plant-based low-density material component is formed from a second starch-based composite, wherein said second starch-based composite comprises a starch ingredient and a humectant ingredient, and wherein said starch ingredient of said second starch-based composite is selected from the group consisting of: potato starch, sweet potato starch, mung bean starch, wheat starch, corn starch, tapioca starch, rice starch and pea starch.

21. The edible pet chew, as recited in claim 15, wherein
said extruded cellular plant-based low-density material component is wrapped about by said extruded plant-based high-density sheet component, wherein at least a portion of said extruded cellular plant-based low-density material component is covered by said extruded plant-based high-density sheet component without exposure, wherein the proportion of said extruded plant-based high-density sheet component to said extruded cellular plant-based low-density material component is in the range between 1:20 and 30:1 by weight in finished product, wherein cross section outline shape of said extruded plant-based high-density sheet component is substantially a narrow rectangle, and wherein an average thickness of said extruded plant-based high-density sheet component ranges from 0.3 mm to 10 mm.

22. The edible pet chew, as recited in claim 14, wherein
said extruded high density sheet member and said cellular material member attach to each other firmly by a co-extrusion process, wherein said extruded high density sheet member forms a first layer portion, wherein said cellular material member forms a second layer portion.

23. The edible pet chew, as recited in claim 22, wherein
said first layer of extruded high density sheet material forms primary exterior surface of finished product, wherein the proportion of said first layer of extruded high density sheet material to said second layer of cellular material is in the range between 1:20 and 20:1 by weight in finished product, wherein cross section outline shape of said first layer of extruded high density sheet material is substantially a narrow rectangle, and wherein an average thickness of said first layer of extruded high density sheet member ranges from 0.3 mm to 10 mm.

24. The edible pet chew, as recited in claim 14, further comprising:
an edible material component, wherein said edible material component is wrapped about by said cellular material component, wherein at least a portion of said edible material component is covered by said cellular material component without exposure, wherein said extruded high density sheet component is an extruded plant-based high density sheet component, wherein said cellular material component is an extruded cellular plant-based low density material component, and wherein each of said extruded plant based high-density sheet component, said extruded cellular plant-based low density material component and said edible material component provides their respectively different function to final product.

25. The edible pet chew, as recited in claim 24, wherein
said edible material component is formed from an animal-ingredient-based material or a flavored material, wherein said animal-ingredient-based material comprises substantially at least 10% animal ingredient by weight, wherein a total animal ingredient proportion by weight existing in said animal-ingredient-based material is greater than any single non-animal ingredient, wherein said flavored material is a plant-based material comprising a plant ingredient and a flavor ingredient, and wherein said flavor ingredient is selected from the group consisting of: a meat ingredient, a meat by-products ingredient, a chicken liver, a hydrolyzed animal protein, a poultry digest, a chicken digest, an artificial beef flavor, an artificial pork flavor and a brewer yeast.
